(19) United States
(12) Patent Application Publication
(10) Pub. No.: US 2007/0067083 A1
(43) Pub. Date: Mar. 22, 2007

(54) Power seat control apparatus

(75) Inventors: Te-Yang Shen, Taoyuan Hsien (TW); Ming Yeh, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/239,248

(22) Filed: Sep. 30, 2005

(30) Foreign Application Priority Data
Sep. 22, 2005 (TW) 94132905

(51) Int. Cl. G06F 17/00

(52) U.S. Cl. 701/49; 701/36

(57) ABSTRACT

A power seat control apparatus is described. The power seat control apparatus includes a measuring module, a control module and a memory module. The measuring module serially connects to a power cord of a power seat to detect current variation data of the power cord and transforms the current variation data into digital output data. The control module receives the digital output data and determines a present position of the power seat. The memory module connecting to the control module stores position data of the power seat. The power seat control apparatus further includes a selecting module for selecting one of the position data from the memory module and moves the power seat thereto with the control module.

### RELATED APPLICATIONS

The present application is based on, and claims priority from, Taiwan Application Serial Number 94132905, filed Sep. 22, 2005, the disclosure of which is hereby incorporated by reference herein in its entirety.

### BACKGROUND OF THE INVENTION

1. Field of Invention

The invention relates to a power seat control apparatus and, in particular, to a power seat control apparatus that uses an indirect measuring method to memorize the position of the power seat.

2. Related Art

With the advance in production techniques and materials, the car industry has tremendous progress in the last century. This also helps promoting other related industries. However, the key factors in the development and designs in vehicles are safety and comfort, independent of whether they are expensive sedans and SUV's or regular cars.

In particular, the comfort of a vehicle has received a lot of attention from both manufacturers and consumers. In the early days, most users are satisfied with cars with comfortable seats. Later on, users start to ask for power seats for the convenience of adjusting their positions for driving. Modem power seats advertise their memory function, so that different users can automatically adjust to a comfortable position according to the position data entered by individual users.

Since most of the time a vehicle is used by a single user, the seats often do not have the memory function. Moreover, the memory power seat is usually installed with a memory motor for memorizing and adjusting the seat. The memory motor normally uses a rotational angular sensor and a rotational angular encoder to directly detect the position signal and feeds back to a controller for adjusting the angle and position. Therefore, it has a higher cost than traditional motors.

In addition to higher cost, the motor of traditional memory power seats is designed to belong to specific seats. Once, the power seat design is fixed, it is difficult for the user to make changes. Therefore, most memory power seats are used in luxury vehicles. For cars without a memory power seat, the user has no option to upgrade the power seat.

### SUMMARY OF THE INVENTION

In view of the foregoing, we know that the conventional memory power seats cannot be widely used in all kinds of vehicles. It is thus highly desirable to provide a power seat control apparatus independent of the driving apparatus of the power seat. This can effectively reduce the production cost of the entire memory power seat. Moreover, the memory power seat can be integrated into all existing power seats to promote the comfort of driving.

Therefore, it is an objective of the invention to provide a driving apparatus for the power seat that can indirectly measure the position of the power seat to fit all kinds of power seats. Therefore, the manual power seats can be readily upgraded into memory power seats.

Another objective of the invention is to provide a driving apparatus for the power seat to reduce the structural difference among different seats. This can reduce the production cost of both the vehicle and the power seat.

It is yet another objective of the invention to provide a driving apparatus for the power seat that serially connects to the power cord of a usual power seat, so that the usual power can be upgraded to a power seat with the memory function. This can make the use of memory power seats more popular.

In accord with the above objectives, the disclosed power seat control apparatus serially connects to a power cord of a power seat. The power seat control apparatus includes a measuring module, a control module, and a memory module. The measuring module serially connects to the power cord of the power seat to measure the current variation data on the power cord and transforms them into digital output data. The control module receives the digital output data to determine the current position of the power seat. The memory module connects to the control module for storing the position data of the power seat.

The power seat control device further includes a selecting module connected to the control module for selecting one of the position data from the memory module and moving the power seat thereto with the control module. The control module utilizes a pulse width modulation (PWM) circuit to control the magnitude of the current on the power cord, thereby moving or stopping the power seat. Moreover, it can perform slow start or stop of the power seat.

The measuring module includes a low-impedance precision resistor, a first signal processor, a second signal processor, and a third signal processor. The first signal processor, the second signal processor, and the third signal processor are connected in series. The first signal processor consists of preferably a second-order band pass filter and a differential amplifier. The second signal processor and the third signal processor consists of preferably a first-order band pass filter and a high-gain amplifier circuit.

The measuring module also includes a saturation processing and hysteresis compensation circuit for saturating the digital output data. The memory module further stores zero point position data and limiting position data, determined when installing the power seat control apparatus. The control module also outputs an instantaneous surge current at the moment the control module starts. Therefore, the power seat is moved instantaneously for a predetermined time, preferably 20 milliseconds (ms), in order to overcome a larger frictional force encountered by a decelerating mechanism at the limiting positions and or starting instant.

The above-mentioned PWM circuit can limit the largest output power of a short stroke to avoid sudden acceleration and deceleration in such strokes. The largest output power of a short stroke is preferably restricted to 80% of the largest power output of a long stroke.

Since the disclosed power seat control apparatus can be directly connected in series to a normal power seat to upgrade it to a memory power seat, it can be used in both new cars or used cars for upgrading the power seats. Moreover, the user may select to upgrade the power seat by himself/herself.

Therefore, the disclosed power seat control apparatus can immediately upgrade conventional power seats into power seats with the memory function, making the memory power seats more popular.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a schematic view of the power seat control apparatus according to a preferred embodiment of the invention;

FIG. 2 is a block diagram of the disclosed power seat control apparatus;

FIG. 3 is a block diagram of the measuring module of the disclosed power seat control apparatus;

FIG. 4 shows the PWM duty as a function of time in the short stroke of the disclosed power seat control apparatus; and

FIG. 5 shows the PWM duty as a function of time in the long stroke of the disclosed power seat control apparatus.

### DETAILED DESCRIPTION OF THE INVENTION

The power seat control apparatus of the invention is independent of the driving apparatus of the power seat and is applicable to all kinds of power seats. It can upgrade usual manual power seats into power seats with the memory function. The power seat control apparatus can reduce the structural difference among the vehicle seats, so that a single power seat design can be used in manual power seats and memory power seats. This can greatly reduce the production cost of the vehicles and their power seats. The present invention will be apparent from the following detailed description, which proceeds with reference to the accompanying drawings, wherein the same references relate to the same elements.

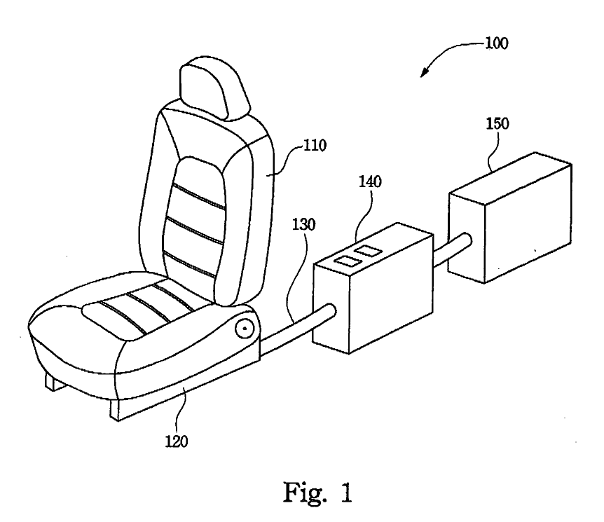

FIG. 1 is a schematic view of the power seat control apparatus according to a preferred embodiment of the invention. As shown in the drawing, the memory power seat 100 has a seat body 110, and uses a driving apparatus 120 to move the seat body 110 forward and backward according to the user's need. The disclosed memory power seat 100 further utilizes a power seat control apparatus 140 connected in series between a power cord 130 and a power supply 150, such as the vehicle battery, to control the power seat. The power cord 130 measures the current variation due to the motor rotation in the driving apparatus 120, some rotational angular motion caused by the motor, or some linear position motion transformed by a conversion mechanism. All such motions present physical quantities with periodic variations. For example, the periodic variations can be the pitch variation in decelerating mechanisms such as the gears or ball screws, the variation in the bias of momentum of the rotor, the variation of the structures of the stator or rotor teeth and the slots of teeth, the variation of the N-S pole structure for a permanent magnet, and the variation in the structure of the armature calibration. When the motor in the driving apparatus 120 starts rotating, the current on the power cord 130 produces a corresponding periodic variation due to the variation in the above-mentioned physical quantities.

The power seat control apparatus 140 serially connects to the power cord 130 and detects the current variation with a precision current variation detecting element. The periodic signal is then converted into the relation between the relative distance of the seat and its position through signal processing. Therefore, even a conventional power seat can be upgraded into a memory power seat by adding the disclosed power seat control apparatus.

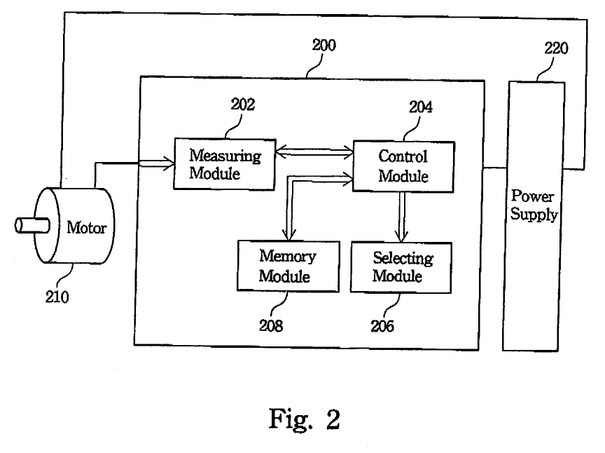

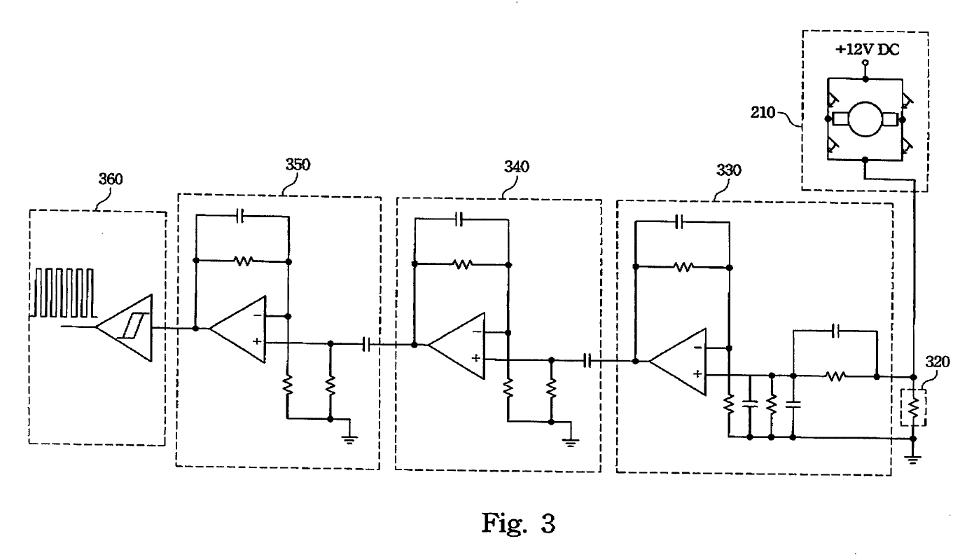

FIGS. 2 and 3 are respectively the schematic views of the disclosed power seat control apparatus and the measuring module thereof. As shown in FIG. 2, the power seat control apparatus 200 includes a measuring module 202, a control module 204, a selecting module 206, and a memory module 208. When measuring the position of the power seat, the power seat control apparatus 200 is connected in series between a motor 210 and a power supply 220. As illustrated in FIG. 3, the electrical current has a period variation as the motor 210 rotates. The disclosed power seat control apparatus uses a signal measuring unit 320 to detect the variation in the current on the motor power cord. Preferably, the signal measuring unit 320 is a low-impedance precision resistor serially connected to the motor power cord. The potential difference between the two ends of the precision resistor is measured, amplified, and processed. The current signal on the motor power cord is detected indirectly. The characteristic frequency signals of various physical quantities that present periodic variations are extracted from the current signal, thereby computing the variation in the relative position of the seat.

In order for the characteristic frequency signal hidden in the current signal variation on the motor power cord measured by the signal measuring unit 320 to be correctly transformed into the seat position data, the disclosed power seat control apparatus further amplifies it using a first signal processing unit 330. The measured signal thus passes through a second-order band pass filter and a differential amplifier. Afterwards, a second signal processing unit 340 and a third signal processing unit 350 are used to further amplify the characteristic frequency signal and to filter the non-characteristic frequency signal. In particular, each of the second signal processing unit 340 and the third signal processing unit 350 is preferably a first-order band pass filter and a high-gain amplifier circuit. Finally, after saturation and hysteresis processing, the characteristic frequency signal is further amplified to saturation. It is simultaneously transformed into an angular pulse, which is output by a digital signal output unit 360.

The digital signal output by the digital signal output unit 360 is transferred to the control module 204 in FIG. 2. The control module 204 uses the digital signals to determine the current position or gesture of the seat and record it in the memory module 208. When the user wants to move the seat to the current position or gesture next time, he or she only needs to select the desired position or gesture from the selecting module 206. The disclosed power seat control apparatus 200 then extracts the position and gesture recorded in the memory module 208 and uses the control module 204 to adjust the power 220 output to the motor 210. The motor 210 is effectively started and stopped at the predetermined memory position or gesture.

Since the disclosed power seat control apparatus indirectly provides the angular or position information for memory and adjustment by detecting an electrical current, the invention can be connected serially to the power cord of a conventional power seat. The conventional power seat can thus be upgraded into a power seat with the memory function. Therefore, either the vehicle manufacturer or the user can readily promote the functions of conventional power seats without changing their designs.

In particular, the vehicle manufacturers can directly use the disclosed power seat control apparatus without changing the motor design. That is, the motor needs not to be the expensive motor with a sensor and an encoder. Therefore, the production cost of the memory power seat can be greatly reduced. Moreover, since the disclosed memory power seat and the regular power seat use the same design, the usage of production modules and equipment can be increased, thus lowering the production cost as well.

For common users, the traditional power seats usually cannot be upgraded into memory power seats. When connecting the disclosed power seat control apparatus in series to the traditional power seats without the memory function, they can be immediately upgraded into the ones with the memory functions. Therefore, the users can choose to upgrade their power seats during services or by themselves later on. The invention thus enables more users to enjoy the convenience and comfort of the memory power seats.

The disclosed power seat control apparatus can be easily installed on a normal power seat, upgrading it to a memory power seat. In order for the users to more comfortably and accurately use the power seats, the disclosed power seat control apparatus further uses a control module to control the moving speed of the power seats.

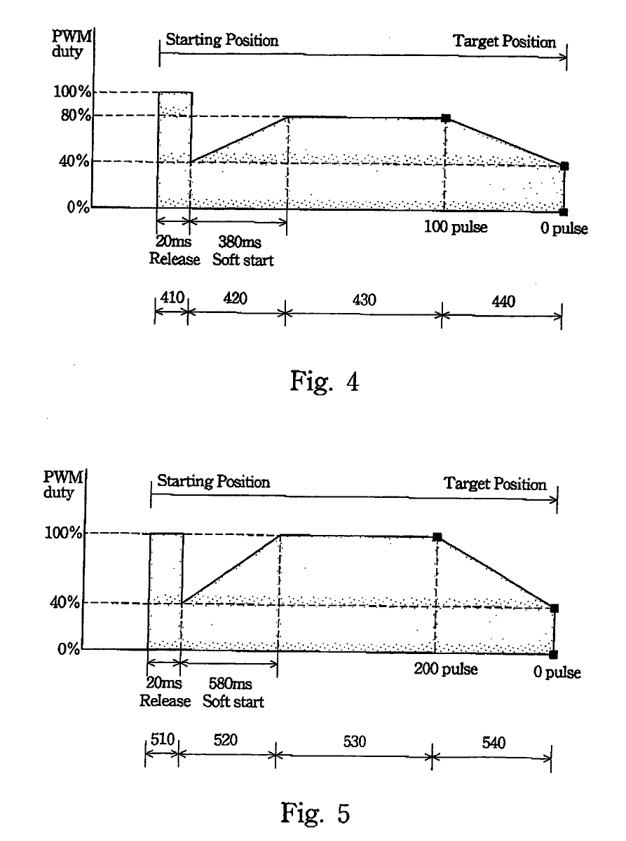

FIG. 4 is a diagram showing the PWM duty as a function of time in a short stroke motion of the disclosed power seat control apparatus; whereas FIG. 5 shows the PWM duty as a function of time in a long stroke motion. Since the motor generates a back current due to the back-electromotive force (back-EMF) at the instant when the power is turned off, there will be accumulating errors in positioning. The invention uses the PWM circuit in the control module to achieve the goal of slow start and slow stop, thereby preventing the back current. As a result, there is still electrical current signal for detection until the motor stops. This can eliminate the accumulating errors in positioning caused by the back-EMF. Please refer to the slow start and slow stop in the first moving period 420, 520, and the third moving period 440, 540 of FIGS. 4 and 5, respectively.

The disclosed power seat control apparatus also uses an instantaneous inrush current to generate a large instantaneous torque. The decelerating mechanism can thus overcome the larger frictional force at the limiting positions and/or the starting instant. Please refer to the starting period 410, 510 in FIGS. 4 and 5.

The disclosed power seat control apparatus utilizes slow start and slow stop to provide a more comfortable mode for moving the seat. It also uses the instantaneous inrush current to overcome the frictional force at the beginning to move the seat for 20 ms. Since the distance during the short stroke of moving is shorter, the instantaneous start and stop will cause discomfort due to the large acceleration and deceleration in the short distance. Therefore, the disclosed power seat control apparatus further maintains the PWM work power during the second moving period 430 at about 80% of the largest power in the short stroke. Therefore, the user feels smaller instantaneous acceleration or deceleration.

In the long stroke, the PWM has a higher work power in order to increase the moving speed. Before the seat reaches the target position, the stroke enters the slow stop period.

In order for normal users and vehicle manufacturers to accurately combine the disclosed power seat control apparatus with usual power seats, the invention also provides a stroke setting function. That is, when the power seat control apparatus is serially connected with the power cord, the seat is first moved to the front and back ends of the stroke. The memory module and the control module thus obtain the moving limits of the power seat. Once the power seat moves to one of these positions, the control apparatus reconfirms it as the zero point or limiting position. This can eliminate the position error as the seat moves back and forth over a long period of time.

The disclosed power seat control apparatus can be serially connected to a power seat without the memory function, upgrading it to a memory power seat. Therefore, it can be installed on a new vehicle or used for upgrading during services or by the user. Any conventional power seat can be immediately upgraded to a memory power seat. This enlarges the usage range of memory power seats.

The power seat control apparatus according to the invention is independent of the driving apparatus of the power seat. This simplifies the structure of power seats, making the design easier. This can greatly reduce the production costs of the vehicles and power seats. With the functions of slow start, slow stop, instantaneous inrush current for overcoming the friction, and the limit in the largest output power in the short stroke of the control module, the memory power seat becomes more comfortable and convenient.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A power seat control apparatus serially connected to a power cord of a power seat, comprising:
a measuring module, which is serially connected to the power cord of the power seat for measuring a current variation data on the power cord and converting it into digital output data;
a control module, which receives the digital output data to determine a current position of the power seat; and
a memory module, which is connected to the control module to store the position data of the power seat.

2. The power seat control apparatus of claim 1 further comprising a selecting module connected to the control module for moving the power seat to one of the positions recorded in the memory module with the control module.

3. The power seat control apparatus of claim 1, wherein the control module controls the magnitude of the electrical current on the power cord for moving or stopping the power seat.

4. The power seat control apparatus of claim 1, wherein the measuring module includes a low-impedance precision resistor.

5. The power seat control apparatus of claim 1, wherein the measuring module further includes a first signal processor consisting of a second-order band pass filter and a differential amplifier.

6. The power seat control apparatus of claim 5, wherein the measuring module further includes a second signal processor serially connecting to a third signal processor and the first signal processor, the second signal processor and the third signal processor consisting of a first-order band pass filter and a high-gain amplifier circuit.

7. The power seat control apparatus of claim 6, wherein the measuring module further includes a saturation processing and hysteresis compensation circuit for saturating the digital output data.

8. The power seat control apparatus of claim 1, wherein the memory module further stores zero point data and limiting position data.

9. The power seat control apparatus of claim 1, wherein the control module outputs an instantaneous inrush current to move the power seat for a predetermined time in the beginning of moving the power seat.

10. The power seat control apparatus of claim 9, wherein the predetermined time is about 20 milliseconds (ms).

11. The power seat control apparatus of claim 1, wherein the control module has the function of slow start and slow stop to avoid position errors caused by a back-electromotive force (back-EMF).

12. The power seat control apparatus of claim 11, wherein the control module further includes a pulse width modulation (PWM) circuit to achieve the functions of slow start and slow stop.

13. The power seat control apparatus of claim 1, wherein the PWM circuit limits the largest output power of a short stroke to avoid sudden acceleration and deceleration.

14. The power seat control apparatus of claim 1, wherein the PWM circuit limits the largest output power in the short stroke to 80% of the largest output power in a long stroke.

15. The power seat control apparatus of claim 1 as a component for services after sale to upgrade a normal power seat to a memory power seat.

16. A power seat control apparatus serially connected to a power cord of a power seat, comprising:
a measuring module, which is serially connected to the power cord of the power seat for measuring a current variation data on the power cord and converting it into digital output data;
a control module, which receives the digital output data to determine a current position of the power seat;
a memory module, which is connected to the control module to store the position data of the power seat; and
a selecting module, which is connected to the control module for moving the power seat to one of the positions recorded in the memory module with the control module.

17. The power seat control apparatus of claim 16, wherein the measuring module includes a low-impedance precision resistor.

18. The power seat control apparatus of claim 17, wherein the measuring module further contains:
a first signal processor;
a second signal processor serially connected to the first signal processor;
a third signal processor serially connected to the second signal processor;
wherein the first signal processor consists of a second-order band pass filter and a differential amplifier, and each of the second signal processor and the third signal processor consists of a first-order band pass filter and a high-gain amplifier circuit.

19. The power seat control apparatus of claim 18, wherein the measuring module further includes a saturation processing and hysteresis compensation circuit for saturating the digital output data.

20. The power seat control apparatus of claim 16, wherein the memory module further stores zero point data and limiting position data.

21. The power seat control apparatus of claim 16, wherein the predetermined time is about 20 milliseconds (ms).

22. The power seat control apparatus of claim 21, wherein the control module has the function of slow start and slow stop to avoid position errors caused by a back-electromotive force (back-EMF).

23. The power seat control apparatus of claim 22, wherein the control module further includes a pulse width modulation (PWM) circuit to achieve the functions of slow start and slow stop.

24. The power seat control apparatus of claim 23, wherein the PWM circuit limits the largest output power in a short stroke to 80% of the largest output power in a long stroke.

25. The power seat control apparatus of claim 16 as a component for services after sale to upgrade a normal power seat to a memory power seat.
